(19) United States
(12) Patent Application Publication
(10) Pub. No.: US 2026/0120262 A1
(43) Pub. Date: Apr. 30, 2026

(54) SOIL PROPERTY ESTIMATION DEVICE, SOIL PROPERTY ESTIMATION METHOD, AND NON-TRANSITORY COMPUTER-READABLE MEDIUM STORING SOIL PROPERTY ESTIMATION PROGRAM

(71) Applicant: TOHOKU UNIVERSITY, Sendai-shi (JP)

(72) Inventors: Tomoaki SATOMI, Sendai-shi (JP); Naoya YAGUCHI, Sendai-shi (JP); Hiroshi TAKAHASHI, Sendai-shi (JP)

(73) Assignee: TOHOKU UNIVERSITY, Sendai-shi (JP)

(21) Appl. No.: 19/368,403

(22) Filed: Oct. 24, 2025

(30) Foreign Application Priority Data
Oct. 28, 2024 (JP) 2024-189388

(51) Int. Cl. G06T 7/00; E02F 9/26; G06T 7/12

(52) U.S. Cl. CPC G06T 7/0002; E02F 9/26; G06T 7/12; G06T 2207/30181

(57) ABSTRACT

A soil property estimation device includes: captured image acquisition processor circuitry configured to acquire a captured image that is an image generated by capturing an image of a target region including soil in a state of shear failure caused by excavation of the soil; and soil property estimation processor circuitry configured to extract a failure region caused by the shear failure based on the captured image and to estimate a soil property that is a property of the soil based on the extracted failure region.

### CROSS REFERENCE TO RELATED APPLICATION

This U.S. patent application claims foreign priority to Japanese Patent Application No. 2024-189388, filed on Oct. 28, 2024, the contents of which are herein incorporated by reference.

### TECHNICAL FIELD

The present disclosure relates to a soil property estimation device, a soil property estimation method, and a non-transitory computer-readable medium storing a soil property estimation program.

### BACKGROUND

In order to determine whether a construction machine is capable of traveling, it is known to use a cone penetration test device that measures a cone index, which is one parameter representing a soil property that is a property of soil (for example, see JP 2008-139140 A). For example, in a construction such as a disaster recovery construction or a civil engineering construction, the cone penetration test device is transported to a plurality of positions, and a cone index is measured at each position.

### SUMMARY

It should be noted that when land to be constructed is relatively large, a soil property may significantly vary depending on positions. Thus, the cone index needs to be measured at a relatively large number of positions to ensure the safety of traveling of a construction machine. However, when the cone penetration test device is used, there is a problem that measuring the cone index independently of the excavation work of soil is labor-intensive. Note that this type of problem may also occur in measurement of parameters representing soil properties other than the cone index.

One object of the present disclosure is to estimate a soil property with high accuracy while excavating soil.

According to one aspect, a soil property estimation device includes a captured image acquisition unit and a soil property estimation unit.

The captured image acquisition unit acquires a captured image that is an image generated by capturing an image of a target region including soil in a state of shear failure caused by excavation of the soil.

The soil property estimation unit extracts a failure region caused by the shear failure based on the captured image, and estimates a soil property that is a property of the soil based on the extracted failure region.

Further, a soil property estimation method includes acquiring a captured image that is an image generated by capturing an image of a target region including soil in a state of shear failure caused by excavation of the soil, extracting a failure region caused by the shear failure based on the captured image, and estimating a soil property that is a property of the soil based on the extracted failure region.

Further, a non-transitory computer-readable medium storing a soil property estimation program that, when executed by a computer, causes the computer to perform acquiring a captured image that is an image generated by capturing an image of a target region including soil in a state of shear failure caused by excavation of the soil, extracting a failure region caused by the shear failure based on the captured image, and estimating a soil property that is a property of the soil based on the extracted failure region.

It is possible to estimate a soil property with high accuracy while excavating soil.

### BRIEF DESCRIPTION OF DRAWINGS

FIG. 1 is a block diagram illustrating a configuration of a soil property estimation device according to a first embodiment.

FIG. 2 is a block diagram illustrating functions of an information processing device according to the first embodiment.

FIG. 3 is an explanatory diagram and a graph illustrating a captured image and changes in values of pixels along reference straight lines.

FIGS. 4A-4C are explanatory diagrams illustrating an example of a binary image, boundaries represented by boundary information, and failure region rectangle candidate groups represented by failure region rectangle candidate group information.

FIGS. 5A-5C are explanatory diagrams illustrating an example of captured images and histograms of a rectangle parameter.

FIGS. 6A-6C are explanatory diagrams illustrating an example of captured images and histograms of a rectangle parameter.

FIG. 7 is a flowchart depicting processing that is performed by the information processing device according to the first embodiment.

FIG. 8 is an explanatory graph showing an example of a relationship between an estimation value and an actual measurement value of a cone index.

FIG. 9 is a flowchart depicting processing that is performed by an information processing device according to a first modification of the first embodiment.

FIG. 10 is a block diagram illustrating a configuration of a soil property estimation device according to a second embodiment.

FIG. 11 is an explanatory graph showing an example of force-related parameters.

FIG. 12 is a flowchart depicting a part of processing that is performed by an information processing device according to the second embodiment.

### DESCRIPTION OF EMBODIMENTS

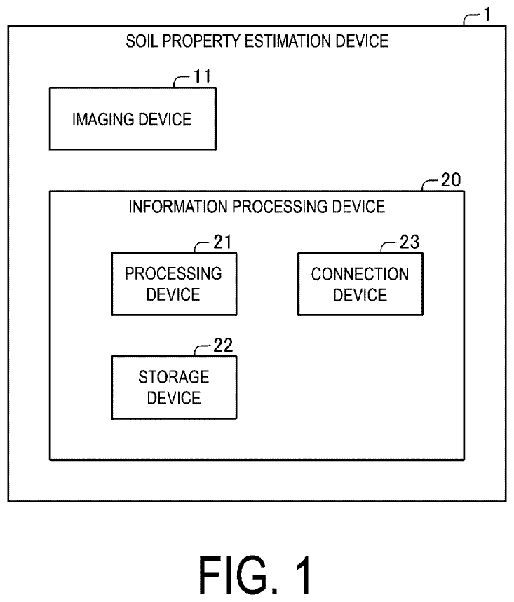

Hereinafter, embodiments of a soil property estimation device, a soil property estimation method, and a non-transitory computer-readable medium storing a soil property estimation program of the present disclosure will be described with reference to FIGS. 1 to 12.

### First Embodiment

### Overview

According to a first embodiment, a soil property estimation device includes a captured image acquisition unit and a soil property estimation unit.

The captured image acquisition unit acquires a captured image that is an image generated by capturing an image of a target region including soil in a state of shear failure caused by excavation of the soil.

The soil property estimation unit extracts a failure region caused by the shear failure based on the captured image, and estimates a soil property that is a property of the soil based on the extracted failure region.

The inventors of the present application have found that there is a strong correlation between a failure mode of soil and a soil property. Examples of the failure mode of soil include a flow mode, a shear mode, and a tensile crack mode as described in Non-Patent Document 1. Moreover, the inventors also have found that the failure mode of soil is likely to be reflected in the failure region caused by shear failure. Thus, the soil property estimation device extracts the failure region caused by the shear failure based on the captured image, and estimates the soil property based on the extracted failure region. This makes it possible to estimate the soil property with high accuracy. As a result, it is possible to estimate the soil property with high accuracy while excavating the soil.
Non-Patent Document 1: Yotaro Hatamura, Kenji Chijiiwa, “Elucidation of Cutting Mechanism of Soil (First Report, Cutting Patterns of Soils)”, Transactions of the Japan Society of Mechanical Engineers, Vol. 40, No. 338, pp. 2945-2955, 1974

Next, the soil property estimation device of the first embodiment will be described in more detail.

### Configuration

As illustrated in FIG. 1, a soil property estimation device 1 includes an imaging device 11 and an information processing device 20.

In this example, the soil property estimation device 1 is mounted on a construction machine including a bucket for excavating soil. Examples of the construction machine are an excavator such as a hydraulic excavator, a power shovel, a shovel loader, or a shovel dozer. Note that only a part of the soil property estimation device 1 may be mounted on the construction machine. In addition, the soil property estimation device 1 may constitute a part of the construction machine.

In this example, the imaging device 11 and the information processing device 20 are separate from each other. It should be noted that the imaging device 11 and the information processing device 20 may be integrated.

For example, the information processing device 20 may be represented as a computer. For example, the information processing device 20 may be at least a part of a smartphone, a television receiver, or the like. For example, the information processing device 20 may be a desktop computer, a laptop computer, a tablet computer, a smartphone, or the like. Note that the information processing device 20 may be constituted by using a plurality of devices communicably connected to each other.

The imaging device 11 captures an image of a target region in response to an imaging command, thereby generating a captured image that is an image representing the imaged target region, and outputting the generated captured image. In this example, the target region is a region including soil in a state of shear failure caused by excavation of the soil. In this example, the excavation of the soil is performed by moving a bucket of a construction machine.

In this example, the captured image is a visible light image. The visible light image is an image representing the intensity of visible light reflected at the target region for each of a plurality of pixels. In this example, the plurality of pixels included in the visible light image are arrayed in a lattice shape.

In this example, the imaging device 11 includes a color camera or a red-green-blue (RGB) camera. Note that the imaging device 11 may be a monochrome camera. In this example, the captured image is a still image. Note that the captured image may be a moving image instead of a still image. In this case, the information processing device 20 may generate a still image from a moving image.

The information processing device 20 includes a processing device 21, a storage device 22, and a connection device 23, which are connected to each other via a bus.

The processing device 21 controls the storage device 22 and the connection device 23 by executing a program stored in the storage device 22. Thus, the processing device 21 implements functions, which will be described below.

In this example, the processing device 21 is a central processing unit (CPU). Note that the processing device 21 may include a micro processing unit (MPU), a graphics processing unit (GPU), or a digital signal processor (DSP) instead of the CPU or in addition to the CPU.

In this example, examples of the storage device 22 include a volatile memory and a non-volatile memory. For example, the storage device 22 includes at least one of a random access memory (RAM), a read only memory (ROM), a semiconductor memory, an organic memory, a hard disk drive (HDD), and a solid state drive (SSD).

The connection device 23 is communicably connected to an external device of the information processing device 20 in a wired or wireless manner. In this example, the connection device 23 is communicably connected to the imaging device 11 in a wired manner. The connection device 23 transmits an imaging command to the imaging device 11. The imaging command is information for triggering imaging of the target region. The connection device 23 receives the captured image output by the imaging device 11, and thus is input with the captured image.

### Functions

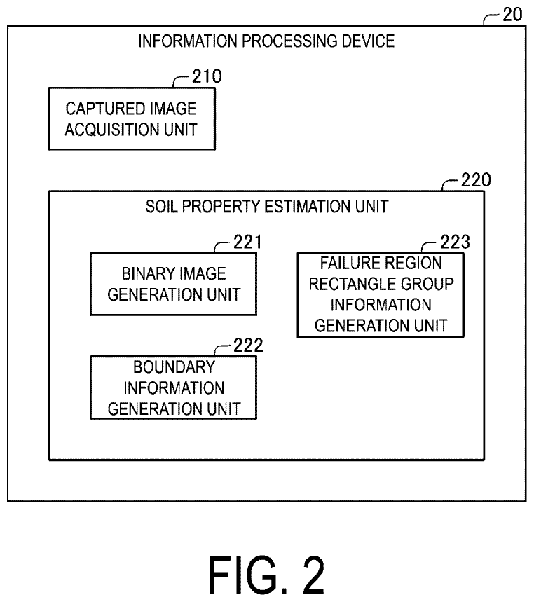

As illustrated in FIG. 2, functions of the information processing device 20 include a captured image acquisition unit 210 and a soil property estimation unit 220. The soil property estimation unit 220 includes a binary image generation unit 221, a boundary information generation unit 222, and a failure region rectangle group information generation unit 223.

The captured image acquisition unit 210 transmits an imaging command to the imaging device 11, and thus receives a captured image output from the imaging device 11 to acquire the captured image (in other words, accepts the captured image). In this example, the captured image acquisition unit 210 acquires M captured images generated by capturing images of the target region at M positions where positions of the bucket are different from each other in excavation of soil performed by the bucket of the construction machine moving along a reference plane. In this example, the reference plane is a vertical plane. M represents an integer of 2 or more. In this example, M represents 23.

The binary image generation unit 221 determines N threshold values based on the M captured images acquired by the captured image acquisition unit 210. N represents an integer of 1 or more. In this example, N represents 5.

In this example, the binary image generation unit 221 selects one captured image from among the M captured images. In this example, the binary image generation unit 221 selects a captured image in a state where the bucket of the construction machine is located at the vertically lowest position (in other words, the deepest position in the soil) among the M captured images.

Note that the binary image generation unit 221 may select a captured image whose acquisition order is a predetermined order among the M captured images. Further, the binary image generation unit 221 may select a captured image from among the M captured images based on a histogram of values of pixels.

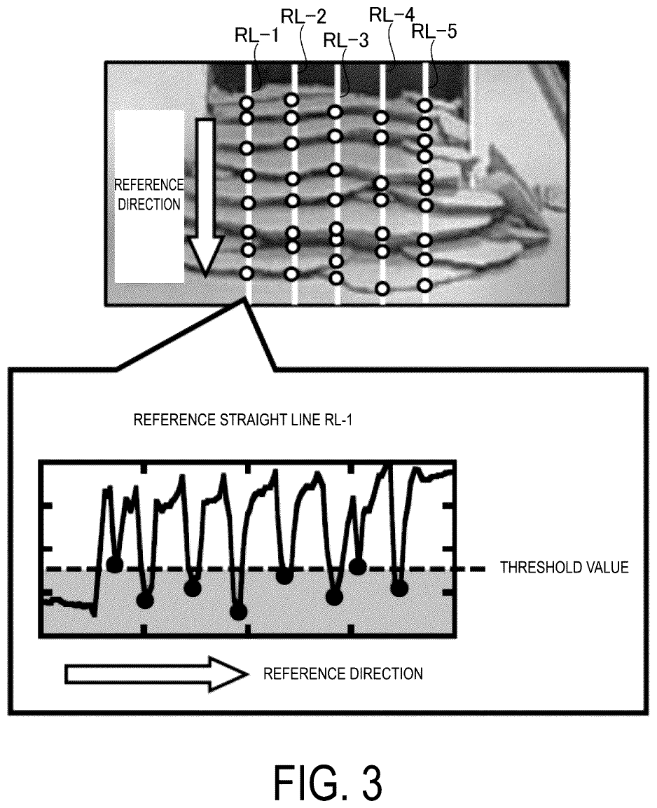

As illustrated in the captured image of FIG. 3, the binary image generation unit 221 acquires, for each of N reference straight lines RL-1 to RL-N parallel to the reference plane and different from each other, the maximum value of local minimum values in changes in values of pixels along the reference straight line RL-n in the selected captured image, and determines the acquired maximum value as a threshold value. Thus, the binary image generation unit 221 determines N threshold values. n represents an integer of 1 to N.

The graph of FIG. 3 represents the changes in the values of the pixels along the reference straight line RL-1. In this example, each of the values of the pixels represents a luminance. In addition, in FIG. 3, the circles represent the local minimum values in the changes in the values of the pixels along the reference straight line RL-n.

Note that each of the values of the pixels may represent a lightness. Further, each of the values of the pixels may represent the intensity of at least one of red, blue, and green.

In this example, the N reference straight lines RL-1 to RL-N are arranged at equal intervals in a direction orthogonal to the reference plane in the captured image. Note that the N reference straight lines RL-1 to RL-N may be arranged at unequal intervals in the direction orthogonal to the reference plane in the captured image.

Note that the binary image generation unit 221 may determine threshold values based on two or more captured images among the acquired M captured images. For example, the binary image generation unit 221 may determine candidates for the threshold values for each captured image in a manner the same as or similar to the above-described method, and may determine all of the determined candidates for the threshold values (in other words, M·N candidates for the threshold values) as the threshold values. Further, for example, the binary image generation unit 221 may determine candidates for the threshold values for each captured image in a manner the same as or similar to the above-described method, and may determine a value obtained by averaging the determined candidates for the threshold value or the maximum value of the determined candidates for the threshold value as the threshold value.

Note that the threshold value may be set in advance. Furthermore, the binary image generation unit 221 may determine the threshold value in accordance with a p-tile method, a mode method, a method called Otsu's binarization, or a method called adaptive binarization.

The binary image generation unit 221 performs binarizing using each of the determined N threshold values on each of the M captured images acquired by the captured image acquisition unit 210, thereby generating M·N binary images.

The binarizing is processing of converting a value of each of a plurality of pixels constituting the captured image into a first value or a second value based on the threshold value. In this example, the first value represents black, and the second value represents white. For example, the first value is 0 and the second value is 255.

In this example, the binarizing includes converting the value of each of the plurality of pixels constituting the captured image into the first value or the second value based on the threshold value, and then performing inverting by replacing the first value and the second value with each other. Note that the binarizing need not include the inverting.

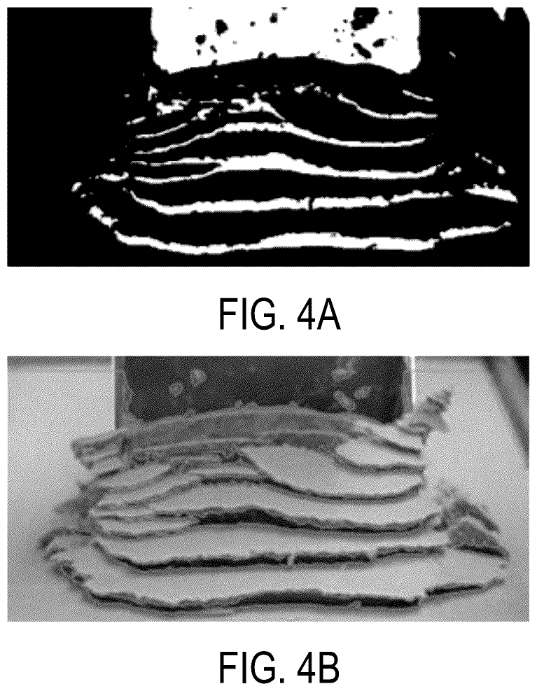

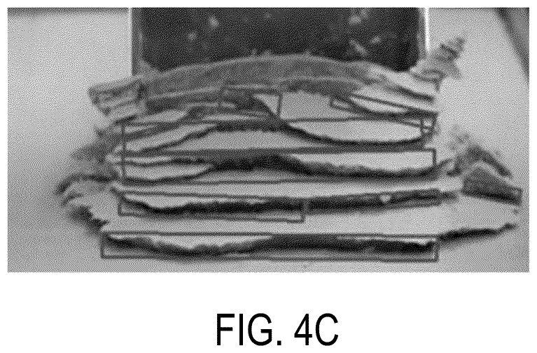

FIG. 4A illustrates an example of a binary image generated by the binary image generation unit 221.

The boundary information generation unit 222 performs boundary extracting on each of the M·N binary images generated by the binary image generation unit 221, thereby generating M·N pieces of boundary information.

The boundary extracting is processing of extracting a boundary between a region having the first value and a region having the second value. The boundary information represents a boundary between the region having the first value and the region having the second value.

FIG. 4B illustrates an example of boundaries represented by the pieces of the boundary information generated by the boundary information generation unit 222. In this example, the boundaries represented by the pieces of the boundary information generated by the boundary information generation unit 222 correspond to boundaries of the failure region caused by the shear failure.

The failure region rectangle group information generation unit 223 performs rectangle generating on each of the M·N pieces of boundary information generated by the boundary information generation unit 222, thereby generating M·N pieces of failure region rectangle candidate group information. The rectangle generating is processing of generating a failure region rectangle candidate group that is a rectangle group including each of closed curve groups included in the boundary represented by the boundary information. The failure region rectangle candidate group information represents the failure region rectangle candidate group.

The failure region rectangle group information generation unit 223 performs shape discarding on each of the generated M·N pieces of failure region rectangle candidate group information.

The shape discarding is processing of discarding a failure region rectangle candidate meeting a predetermined shape discarding condition from among the failure region rectangle candidate groups represented by the pieces of the failure region rectangle candidate group information.

In this example, the shape discarding condition is a condition that a long side of the failure region rectangle candidate is smaller than a length obtained by multiplying a width of the bucket by a predetermined coefficient in the captured image. In this example, the coefficient is 0.18. Note that the coefficient may be a value within a range from 0.10 to 0.30.

FIG. 4C illustrates an example of the failure region rectangle candidate group represented by the failure region rectangle candidate group information after the shape discarding.

The failure region rectangle group information generation unit 223 generates, for each captured image, failure region rectangle group information by performing duplication discarding on each of a failure region rectangle candidate group information pair including two pieces of failure region rectangle candidate group information generated for two adjacent threshold values among the N pieces of failure region rectangle candidate group information after the shape discarding, which are generated based on the captured image.

The duplication discarding is processing of discarding a failure region rectangle candidate meeting a predetermined duplication discarding condition from among the failure region rectangle candidate groups represented by the pieces of the failure region rectangle candidate group information so as to discard a failure region rectangle candidate duplicated between the pieces of the failure region rectangle candidate group information constituting the failure region rectangle candidate group information pair. The duplication discarding condition is a condition that the center of another failure region rectangle candidate is included inside the failure region rectangle candidate that is a target of the determination of whether to discard the failure region rectangle candidate.

In this example, in the duplication discarding, the failure region rectangle candidate constituting the failure region rectangle candidate group represented by the failure region rectangle candidate group information based on the binary image generated based on the larger threshold value of the two pieces of failure region rectangle candidate group information constituting the failure region rectangle candidate group information pair is a target of the determination of whether to discard or not.

In this example, in the duplication discarding, whether the duplication discarding condition is met is determined in accordance with the Crossing Number Algorithm. Note that in the duplication discarding, whether the duplication discarding condition is met may be determined in accordance with a Winding Number Algorithm instead of the Crossing Number Algorithm.

In this manner, the failure region rectangle group information generation unit 223 performs the discarding on the M·N pieces of boundary information generated by the boundary information generation unit 222, thereby generating the failure region rectangle group information for each of the M captured images acquired by the captured image acquisition unit 210.

The discarding is processing of discarding a failure region rectangle candidate meeting the predetermined discarding condition from among the failure region rectangle candidate groups that are rectangle groups including closed curve groups included in boundaries represented by the M·N pieces of boundary information. In this example, the discarding includes shape discarding and duplication discarding. Further, in this example, the discarding condition includes a shape discarding condition and a duplication discarding condition. The failure region rectangle group information represents a failure region rectangle group that is a failure region rectangle candidate group not meeting the discarding condition among the failure region rectangle candidate groups.

In this example, the generation of the failure region rectangle group information corresponds to the extraction of the failure region caused by the shear failure.

The soil property estimation unit 220 calculates a rectangle parameter for each of the failure region rectangle groups (in other words, each failure region rectangle) represented corresponding to the M pieces of failure region rectangle group information generated by the failure region rectangle group information generation unit 223. In this example, Equation 1 expresses a rectangle parameter d.

$$d = \sqrt{{K}_{A R}^{2} + {K}_{G R}^{2}} \qquad [ Math . 1 ]$$

In Equation 1, K_{AR} represents a square ratio expressed by Equation 2, and K_{GR} represents a gradient ratio expressed by Equation 3. Note that the square ratio may be expressed as a length-to-width ratio or an aspect ratio.

As expressed in Equation 1, the rectangle parameter d is a parameter that increases as the square ratio K_{AR} increases and increases as the gradient ratio K_{GR} increases.

$${K}_{A R} = 100 \frac{{L}_{1}}{{L}_{2}} \qquad [ Math . 2 ]$$

$${K}_{G R} = 100 \frac{ϕ}{90} \qquad [ Math . 3 ]$$

In Equation 2, L₁ represents a length of a short side of a failure region rectangle, and L₂ represents a length of the long side of the failure region rectangle. As expressed in Equation 2, the square ratio K_{AR} is a parameter that increases as the failure region rectangle approaches a square. Note that the square ratio K_{AR} may be expressed by a mathematical equation different from Equation 2.

In addition, in Equation 3, φ represents an inclination angle that is an angle at which the long side of the failure region rectangle is inclined with respect to a reference line. In this example, the inclination angle φ has a value within a range from 0 to 90 degrees. In this example, the reference line extends in a direction orthogonal to the reference plane in the captured image.

As expressed in Equation 3, the gradient ratio K_{GR} is a parameter that increases as the angle at which the long side of the failure region rectangle is inclined with respect to the reference line increases. Note that the gradient ratio K_{GR} may be expressed by a mathematical equation different from Equation 3.

Moreover, the rectangle parameter d may be expressed by a mathematical equation different from Equation 1. For example, the rectangle parameter d may be expressed by Equation 4 or Equation 5.

$$d = {K}_{AR}^{2} + {K}_{G R}^{2} \qquad [ Math . 4 ]$$

$$d = {K}_{A R} + {K}_{GR} \qquad [ Math . 5 ]$$

The soil property estimation unit 220 acquires a histogram (in other words, a frequency distribution) of the calculated rectangle parameter d.

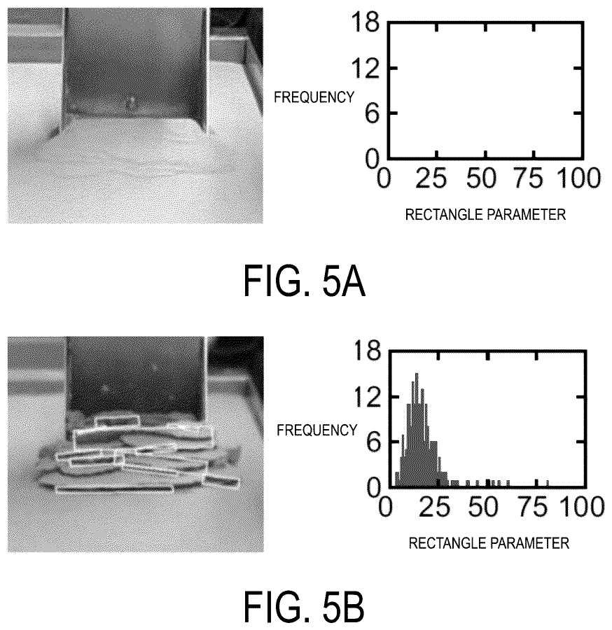

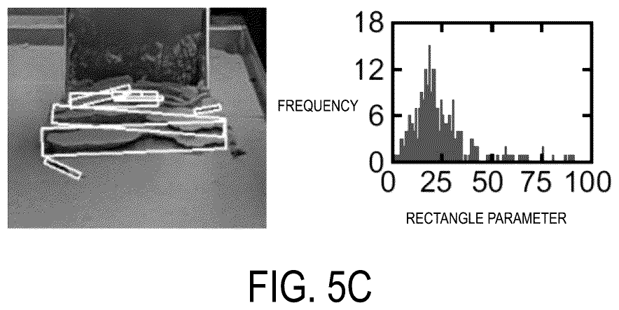

FIGS. 5A-5C illustrate an example of captured images acquired for first sandy soil having a median diameter of 0.09 mm and histograms of a rectangle parameter. FIG. 5A illustrates a case where a water content is 0% and a degree of saturation is 0%. FIG. 5B illustrates a case where a water content is 10% and a degree of saturation is 22%. FIG. 5C illustrates a case where a water content is 20% and a degree of saturation is 44%.

The water content is a value obtained by dividing a weight of water contained in soil by a dry mass of the soil, and is expressed as a percentage. The degree of saturation is a value obtained by dividing a volume of water contained in a gap of soil by a volume of the gap of the soil, and is expressed as a percentage.

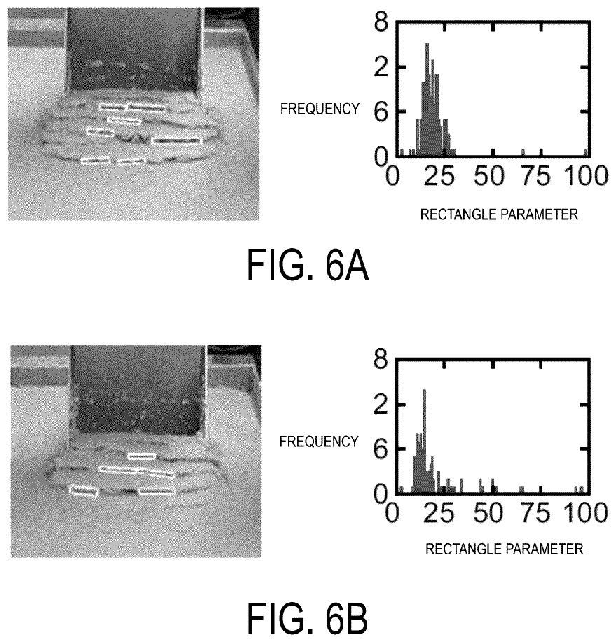

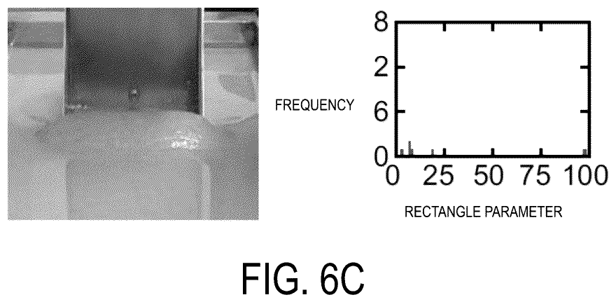

FIGS. 6A-6C illustrate an example of captured images acquired for second sandy soil having a median diameter of 0.36 mm and histograms of a rectangle parameter. FIG. 6A illustrates a case where a water content is 10% and a degree of saturation is 30%. FIG. 6B illustrates a case where a water content is 20% and a degree of saturation is 60%. FIG. 6C illustrates a case where a degree of saturation is 100%.

The soil property estimation unit 220 acquires a most frequent value M and a frequency f_{M} of the most frequent value M in the acquired histogram. The soil property estimation unit 220 estimates a soil property based on the acquired most frequent value M and the acquired frequency f_{M} of the most frequent value M. In this example, the estimation of the soil property is estimation of a cone index that is a parameter representing the soil property. The cone index is a parameter obtained by measuring a resistance force when a conical probe is pushed into the ground. For example, the cone index is measured in accordance with the method defined by the Japanese Industrial Standards (JIS) A1228 (Test method for cone index of compacted soils).

In this example, the soil property estimation unit 220 estimates a cone index q_{c} based on the acquired most frequent value M, the acquired frequency f_{M} of the acquired most frequent value M, and Equation 6.

$${q}_{c} = \{ \begin{matrix}{{k}_{1} ( {f}_{M} + 1 )}^{{k}_{2}} & if {f}_{M} \leq {T}_{1} \\ {k}_{3} + {k}_{4} M + {k}_{5} {f}_{M} + {k}_{6} {Mf}_{M} & if {f}_{M} > {T}_{1}\end{matrix} \qquad [ Math . 6 ]$$

In Equation 6, T₁ represents a condition threshold value. In this example, the condition threshold value T₁ represents 4. Note that the condition threshold value T₁ may represent a value other than 4. In addition, in Equation 6, k₁, k₂, k₃, k₄, k₅, and k₆ represent a first coefficient, a second coefficient, a third coefficient, a fourth coefficient, a fifth coefficient, and a sixth coefficient, respectively. In this example, the first coefficient k₁ to the sixth coefficient k₆ are set in advance.

In this manner, the soil property estimation unit 220 extracts the failure region caused by the shear failure based on the captured images acquired by the captured image acquisition unit 210, and estimates the soil property based on the extracted failure region.

Note that the soil property estimation unit 220 may estimate at least one of a type of soil and a state of the soil instead of the cone index q_{c} or in addition to the cone index q_{c}. Examples of the type of the soil include gravelly soil, sandy soil, clayey soil, or the like. For example, a parameter or parameters representing the state of the soil may include at least one of a water content, a degree of saturation, and a volumetric water content.

The volumetric water content is a value obtained by dividing a volume of water contained in soil by a total volume of the soil.

Additionally, the soil property estimation unit 220 may estimate at least one of cohesion and an internal friction angle instead of the cone index q_{c} or in addition to the cone index q_{c}.

Further, the soil property estimation unit 220 may estimate the soil property based on both or one of the square ratio K_{AR} and the gradient ratio K_{GR} instead of the rectangle parameter d.

Note that the information processing device 20 may perform predetermined pre-processing on the captured image acquired by the captured image acquisition unit 210. For example, the pre-processing may include trimming and filtering that is performed subsequent to the trimming.

The trimming is processing of cutting out a part of the captured image so as not to include an object other than a region including soil in a state of shear failure caused by excavation of the soil.

The filtering is processing of applying a bilateral filter to the captured image subjected to the trimming so as to suppress a shadow as noise. For example, in the filtering, a bilateral filter may be repeatedly applied a plurality of times. Note that the pre-processing may omit either the trimming or the filtering. In addition, the filtering may use a Gaussian filter or a median filter instead of the bilateral filter.

Further, the information processing device 20 may perform opening on the binary image generated by the binary image generation unit 221. For example, the opening includes P times of eroding and P times of dilating that is performed subsequent to the P times of eroding. P represents an integer of 1 or more.

The eroding is filtering in which, for each of the plurality of pixels constituting the binary image, when at least one pixel included in a region of a kernel centered at a target pixel that is the pixel has the first value, the value of the target pixel is replaced with the first value. In other words, the eroding is filtering using a kernel. The eroding is processing also referred to as Erosion.

The dilating is filtering in which, for each of the plurality of pixels constituting the binary image, when at least one pixel included in a region of a kernel centered at a target pixel that is the pixel has the second value, the value of the target pixel is replaced with the second value. In other words, the dilating is filtering using a kernel. The dilating is processing also referred to as Dilation.

For example, the kernel is square. It should be noted that the kernel may be a rectangle other than a square, a circle, an ellipse, or the like.

### Operation

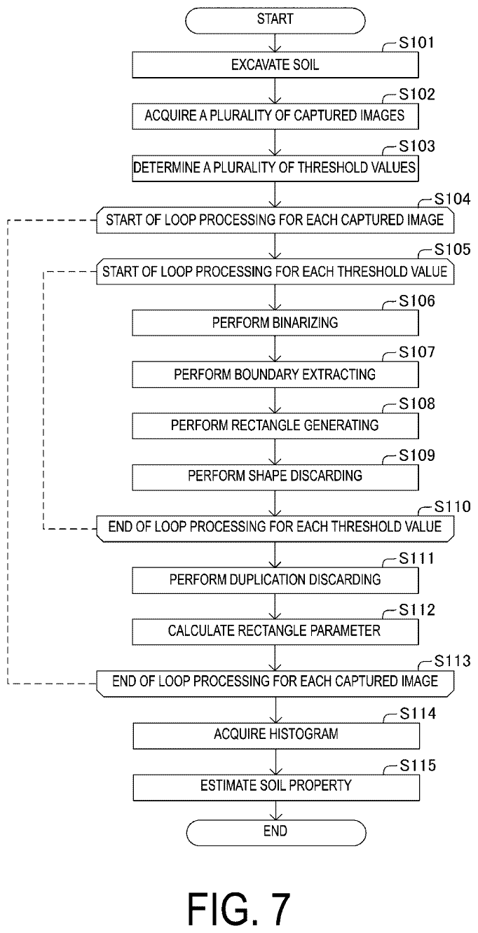

Next, an operation of the soil property estimation device 1 will be described with reference to FIG. 7.

The soil property estimation device 1 starts processing represented by the flowchart in FIG. 7.

First, a construction machine excavates soil by moving a bucket thereof along a reference plane (step S101).

The information processing device 20 individually transmits M imaging commands to the imaging device 11 at M time points different from each other in a period in which the construction machine excavates soil, and receives M captured images output from the imaging device 11 to acquire the M captured images (step S102).

Next, the information processing device 20 determines N threshold values based on the M captured images acquired in step S102 (step S103).

Then, the information processing device 20 performs first loop processing (step S104 to step S113) using each of the M captured images acquired in step S102 as a processing target one by one in order.

In the first loop processing, the information processing device 20 performs second loop processing (step S105 to step S110) using each of the N threshold values as a processing target one by one in order.

In the second loop processing, the information processing device 20 performs binarizing using the threshold value as the processing target on the captured image as the processing target, thereby generating a binary image (step S106). Next, in the second loop processing, the information processing device 20 performs boundary extracting on the binary image generated in step S106, thereby generating boundary information (step S107).

After that, in the second loop processing, the information processing device 20 performs rectangle generating on the boundary information generated in step S107, thereby generating failure region rectangle candidate group information (step S108). Next, in the second loop processing, the information processing device 20 performs shape discarding on the failure region rectangle candidate group information generated in step S108 (step S109).

Then, the information processing device 20 performs the second loop processing (step S105 to step S110) for all of the N threshold values, and then proceeds to step S111.

Next, in the first loop processing, the information processing device 20 performs the duplication discarding on the N pieces of failure region rectangle candidate group information generated based on the captured image as the processing target and subjected to the shape discarding in step S109, thereby generating each piece of failure region rectangle group information for the captured image as the processing target (step S111).

Next, in the first loop processing, the information processing device 20 calculates a rectangle parameter for each of the failure region rectangle groups represented by the pieces of the failure region rectangle group information generated in step S111 (step S112).

Then, the information processing device 20 performs the first loop processing (step S104 to step S113) on all the acquired M captured images, and then proceeds to step S114.

Next, the information processing device 20 acquires a histogram of the rectangle parameter calculated in step S112 for each of the M captured images (step S114).

Next, the information processing device 20 acquires a most frequent value M and a frequency f_{M} of the most frequent value M in the histogram acquired in step S114, and estimates a soil property (in this example, a cone index q_{c}) based on the acquired most frequent value M and the acquired frequency f_{M} of the most frequent value M (step S115).

After that, the information processing device 20 ends the processing illustrated in FIG. 7.

Note that the processing of step S111 may be performed immediately after step S109 in the second loop processing.

As described above, the soil property estimation device 1 of the first embodiment includes the captured image acquisition unit 210 and the soil property estimation unit 220.

The captured image acquisition unit 210 acquires a captured image that is an image generated by capturing an image of a target region including soil in a state of shear failure caused by excavation of the soil.

The soil property estimation unit 220 extracts a failure region caused by the shear failure based on the captured image, and estimates a soil property that is a property of the soil, based on the extracted failure region.

The inventors of the present application have found that there is a strong correlation between a failure mode of soil and a soil property. Moreover, the inventors also have found that the failure mode of soil is likely to be reflected in a failure region caused by shear failure. Thus, the soil property estimation device 1 extracts the failure region caused by the shear failure based on the captured image, and estimates the soil property based on the extracted failure region. This makes it possible to estimate the soil property with high accuracy. As a result, it is possible to estimate the soil property with high accuracy while excavating the soil.

Further, in the soil property estimation device 1 of the first embodiment, the soil property estimation unit 220 estimates the soil property based on at least one of a square ratio K_{AR} that increases as the rectangle including the extracted failure region approaches a square and a gradient ratio K_{GR} that increases as the angle at which the long side of the rectangle is inclined with respect to the reference line increases.

The failure mode of soil is likely to be reflected in each of a length of the continuous failure region and an angle at which the failure region is inclined with respect to the reference line. Thus, the soil property estimation device 1 makes it possible to estimate the soil property with high accuracy.

Further, in the soil property estimation device 1 of the first embodiment, the soil property estimation unit 220 estimates the soil property based on the rectangle parameter d that increases as the square ratio K_{AR} increases and increases as the gradient ratio K_{GR} increases.

The inventors of the present application have found that the rectangle parameter d, which increases as the square ratio K_{AR} increases and increases as the gradient ratio K_{GR} increases, is likely to reflect the soil property. Thus, the soil property estimation device 1 estimates the soil property based on the rectangle parameter d. This makes it possible to estimate the soil property with high accuracy.

Further, in the soil property estimation device 1 of the first embodiment, the soil property estimation unit 220 estimates the soil property based on the most frequent value M and the frequency f_{M} of the most frequent value M in the histogram of the rectangle parameter d.

The inventors of the present application have found that the most frequent value M and the frequency f_{M} of the most frequent value M in the histogram of the rectangle parameter d easily reflect the soil property. Thus, the soil property estimation device 1 estimates the soil property based on the most frequent value M and the frequency f_{M} of the most frequent value M in the histogram of the rectangle parameter d. This makes it possible to estimate the soil property with high accuracy.

Further, in the soil property estimation device 1 of the first embodiment, the soil property estimation unit 220 includes a binary image generation unit 221, a boundary information generation unit 222, and a failure region rectangle group information generation unit 223.

The binary image generation unit 221 performs binarizing on the captured image to convert the value of each of the plurality of pixels constituting the captured image into the first value or the second value based on the threshold value, thereby generating a binary image.

The boundary information generation unit 222 performs boundary extracting on the binary image, thereby extracting a boundary between a region having the first value and a region having the second value, and thus generating boundary information representing the boundary.

The failure region rectangle group information generation unit 223 performs discarding on the boundary information, thereby discarding a failure region rectangle candidate meeting a predetermined discarding condition from among failure region rectangle candidate groups that are rectangle groups including closed curve groups included in the boundary represented by the boundary information, and thus generating failure region rectangle group information indicating a failure region rectangle group that is a failure region rectangle candidate group not meeting the discarding condition, from among the failure region rectangle candidate groups.

In the soil property estimation unit 220, an individual failure region rectangle group represented by the generated failure region rectangle group information is a rectangle including the extracted failure region.

According to this, since the binarizing is performed, a contour of an individual failure region can be reflected on the boundary extracted by the boundary extracting with high accuracy. Furthermore, the failure region rectangle candidate groups including the closed curve groups included in the boundary are subjected to the discarding, making it possible to appropriately discard the failure region rectangle candidate that does not correspond to an actual failure region. This enables highly accurate extraction of each failure region. As a result, the soil property can be estimated with high accuracy.

Moreover, in the soil property estimation device 1 of the first embodiment, the binary image generation unit 221 performs binarizing regarding each of a plurality of threshold values different from each other, thereby generating a plurality of binary images. Furthermore, the boundary information generation unit 222 performs boundary extracting on each of the plurality of binary images, thereby generating a plurality of pieces of boundary information.

The failure region rectangle group information generation unit 223 performs discarding on the plurality of pieces of boundary information, thereby generating failure region rectangle group information. The discarding condition includes a duplication discarding condition that the center of another failure region rectangle candidate is included inside the failure region rectangle candidate to be determined.

In many cases, the failure region from which the contour is extracted changes depending on the threshold value used in the binarizing. Thus, by performing the binarizing on each of the plurality of threshold values different from each other, the number of the failure regions from which the contours are extracted can be increased. Furthermore, a failure region rectangle candidate is discarded when the center of another failure region rectangle candidate is included inside the failure region rectangle candidate, suppressing the extraction of a plurality of failure region rectangles for the same failure region. Thus, an individual failure region can be extracted with high accuracy. As a result, the soil property can be estimated with high accuracy.

Further, in the soil property estimation device 1 of the first embodiment, soil is excavated by moving the bucket of the construction machine along the reference plane. The binary image generation unit 221 uses, as each of the plurality of threshold values, the maximum value of local minimum values in changes in values of pixels along a straight line for each of a plurality of straight lines parallel to the reference plane and different from each other in the captured image.

It is often observed that the values of pixels in a captured image are likely to vary in a direction orthogonal to the reference plane. Thus, the soil property estimation device 1 determines a threshold value corresponding to each of the plurality of straight lines parallel to the reference plane based on the values of pixels along the straight line. This makes it possible to appropriately acquire the plurality of threshold values corresponding to a contour of the actual failure region. As a result, the soil property can be estimated with high accuracy.

Further, in the soil property estimation device 1 of the first embodiment, examples of the parameter representing the soil property include the cone index q_{c}.

Furthermore, in the soil property estimation device 1 of the first embodiment, the soil property is represented by at least one of a type of soil and a state of soil, and examples of the parameter representing the state of soil includes at least one of a water content, a degree of saturation, and a volumetric water content.

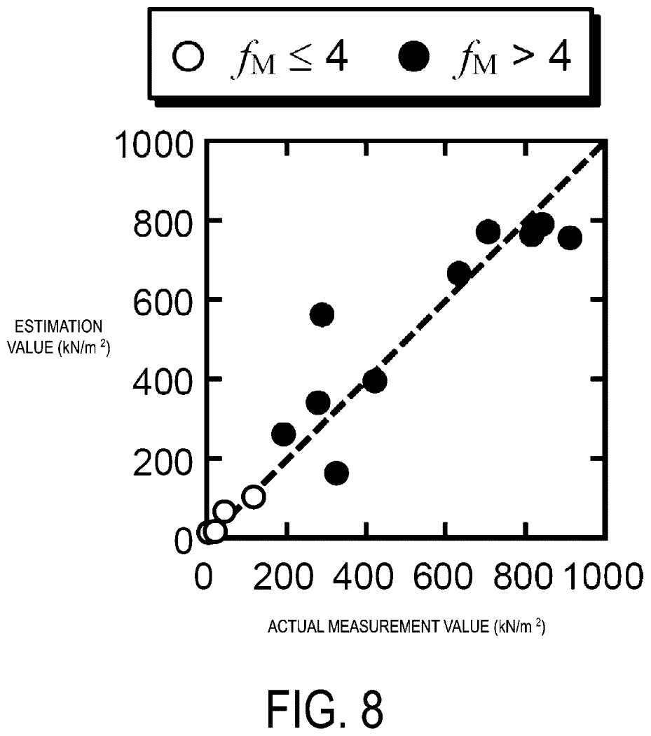

FIG. 8 shows an example of a relationship between the cone index q_{c} estimated by the soil property estimation device 1 (in other words, an estimation value of the cone index) and the measured cone index (in other words, a measurement value of the cone index) for soil having various soil properties. As shown in FIG. 8, the soil property estimation device 1 can estimate the soil property with high accuracy.

The soil property estimation device 1 of the first embodiment estimates the soil property based on the frequency f_{M} of the most frequent value M in the histogram of the rectangle parameter. Note that the soil property estimation device 1 of the first embodiment may estimate the soil property based on a value obtained by dividing the frequency f_{M} of the most frequent value M by the number of rectangle parameters in total (in other words, a normalized frequency), instead of the frequency f_{M} of the most frequent value M.

### First Modification of First Embodiment

Next, a soil property estimation device of a first modification of the first embodiment will be described. The soil property estimation device of the first modification of the first embodiment is different from the soil property estimation device of the first embodiment in that only one threshold value is used in the binarizing. The following description will be made mainly on the difference. Note that in the description of the first modification of the first embodiment, the same reference signs as those used in the first embodiment denote the same or substantially similar components.

### Functions

The binary image generation unit 221 of the first modification of the first embodiment selects one captured image from among the M captured images, similarly to the binary image generation unit 221 of the first embodiment. The binary image generation unit 221 acquires the maximum value of local minimum values in changes in values of pixels along the reference straight line parallel to the reference plane in the selected captured image, and determines the acquired maximum value as a threshold value.

In this example, the number N of threshold values to be determined represents 1. In this example, the discarding includes the shape discarding and does not include the duplication discarding. In this example, the discarding condition includes the shape discarding condition and does not include the duplication discarding condition.

### Operation

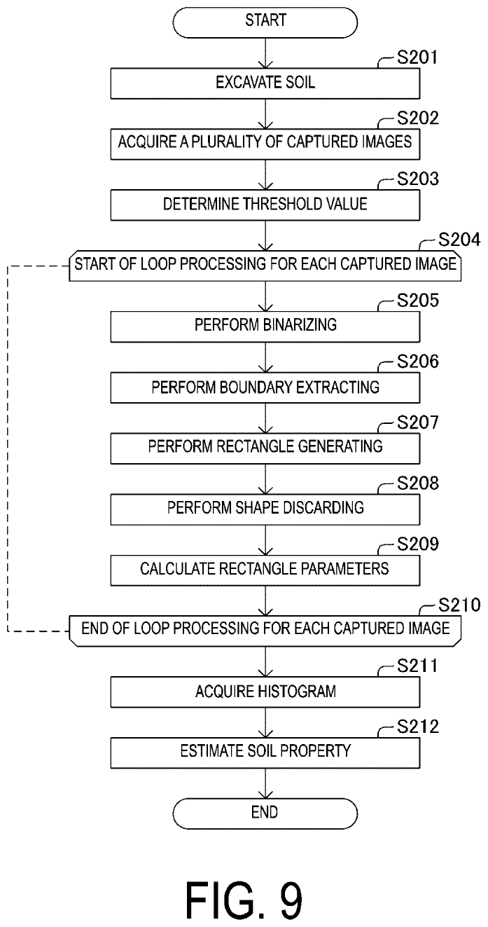

The soil property estimation device 1 of the first modification of the first embodiment starts processing illustrated in FIG. 9 instead of the processing illustrated in FIG. 7.

First, a construction machine excavates soil by moving a bucket thereof along a reference plane (step S201).

The information processing device 20 transmits M imaging commands to the imaging device 11 at M time points different from each other in a period in which the construction machine excavates soil, and receives M captured images output from the imaging device 11 to acquire the M captured images (step S202).

Next, the information processing device 20 determines one threshold value based on the M captured images acquired in step S202 (step S203).

Next, the information processing device 20 performs first loop processing (step S204 to step S210) in which each of the M captured images acquired in step S202 is used as a processing target one by one in order.

In the first loop processing, the information processing device 20 performs binarizing using the threshold value determined in step S203 on the captured image as the processing target, thereby generating a binary image (step S205).

Next, in the first loop processing, the information processing device 20 performs the boundary extracting, the rectangle generating, and the shape discarding on the captured image as the processing target (step S206 to step S208), similarly to step S107 to step S109 in FIG. 7.

Next, in the first loop processing, the information processing device 20 calculates a rectangle parameter for each of the failure region rectangle groups represented by the pieces of failure region rectangle group information, each of which is the failure region rectangle candidate group information subjected to the shape discarding in step S208, for the captured image as the processing target (step S209).

Then, the information processing device 20 performs the first loop processing (step S204 to step S210) on all the acquired M captured images, and then proceeds to step S211.

Next, the information processing device 20 acquires a histogram of the rectangle parameter, and estimates the soil property (in this example, the cone index q_{c}) based on the acquired histogram, similarly to step S114 to step S115 in FIG. 7 (step S211 to step S212).

Thus, the information processing device 20 ends the processing illustrated in FIG. 9.

As described above, the soil property estimation device 1 of the first modification of the first embodiment provides operations and effects the same as or similar to those of the soil property estimation device 1 of the first embodiment.

Further, regarding the soil property estimation device 1 of the first modification of the first embodiment, the construction machine excavates soil by moving the bucket thereof along the reference plane. Furthermore, the binary image generation unit 221 uses, as a threshold value, the maximum value of local minimum values in changes in values of pixels along the straight line parallel to the reference plane in the captured image.

It is often observed that the values of pixels in the captured image are likely to vary in a direction orthogonal to the reference plane. Thus, the soil property estimation device 1 determines the threshold value based on the values of the pixels along the straight line parallel to the reference plane. Accordingly, the threshold value corresponding to the contour of the actual failure region can be appropriately acquired. As a result, the soil property can be estimated with high accuracy.

### Second Embodiment

Next, a soil property estimation device of a second embodiment will be described. The soil property estimation device of the second embodiment is different from the soil property estimation device of the first embodiment in that the soil property is estimated also based on a resistance force received by the bucket in movement for excavating soil. The following description will be made mainly on the difference. Note that in the description of the second embodiment, the same reference signs as those used in the first embodiment denote the same or substantially similar components.

### Configuration

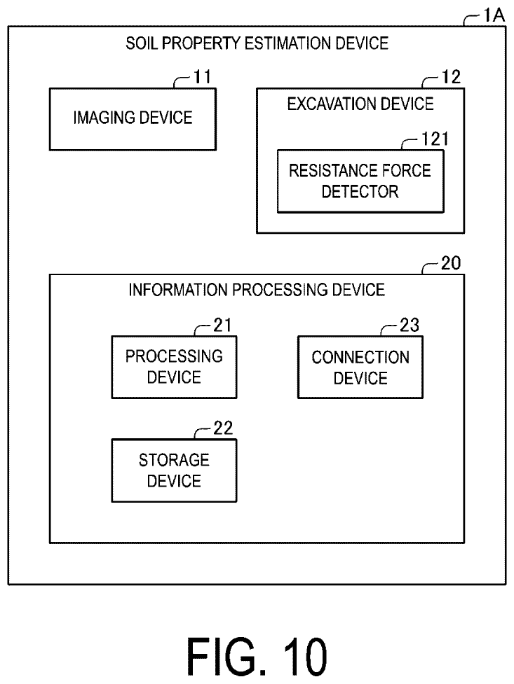

As illustrated in FIG. 10, a soil property estimation device 1A of the second embodiment includes an excavation device 12 in addition to the configuration included in the soil property estimation device 1 of the first embodiment.

The excavation device 12 is a bucket of a construction machine. In this example, the excavation device 12 is driven by hydraulic pressure. Note that the excavation device 12 may be driven by electric power. In this example, the imaging device 11 is positioned facing the excavation device 12. Note that the imaging device 11 may be mounted on the excavation device 12.

The excavation device 12 includes a resistance force detector 121. The resistance force detector 121 detects a resistance force received by the excavation device 12 in movement for excavating soil. In this example, the resistance force detector 121 detects a resistance force by detecting a magnitude of hydraulic pressure for driving the excavation device 12. In this example, the resistance force detector 121 corresponds to a resistance force detection unit.

Note that the resistance force detector 121 may detect a resistance force by using a force sensor, a pressure sensor, or a load sensor.

In this example, the resistance force detector 121 detects a rotation angle of the bucket together with the resistance force. In this example, a central axis of rotation corresponding to the rotation angle of the bucket extends in the horizontal direction. For example, the resistance force detector 121 detects the rotation angle of the bucket by using a rotation angle sensor. Note that the resistance force detector 121 may detect the rotation angle of the bucket by using a displacement sensor attached to a hydraulic cylinder that drives the bucket, instead of the rotation angle sensor.

In this manner, in this example, the resistance force detector 121 detects the resistance force in association with the rotation angle of the bucket.

### Functions

The soil property estimation unit 220 of the second embodiment estimates the soil property based on the resistance force detected by the resistance force detector 121 in addition to the most frequent value M and the frequency f_{M} of the most frequent value M in the histogram of the rectangle parameter d.

In this example, the soil property estimation unit 220 estimates the cone index q_{c} based on the most frequent value M and the frequency f_{M} of the most frequent value M in the histogram of the rectangle parameter d, the resistance force detected by the resistance force detector 121, and Equation 7.

$${q}_{c} = \{ \begin{matrix}{s}_{1} {e}^{{s}_{n} e} & if {f}_{M} \leq {T}_{2} \\ {s}_{1} ln ( α ) + {s}_{2} {e}^{{s}_{3} n} & if {f}_{M} > {T}_{2} and M \leq {T}_{3} \\ {s}_{1} ln ( α ) + {s}_{2} {e}^{{s}_{3} n} + {s}_{4} {F}_{ave}^{{s}_{5}} & if {f}_{M} > {T}_{2} and M > {T}_{3}\end{matrix} \qquad [ Math . 7 ]$$

In Equation 7, T₂ represents a first condition threshold value, and T₃ represents a second condition threshold value. In this example, the first condition threshold value T₂ represents 3. Note that the first condition threshold value T₂ may represent a value other than 3. In this example, the second condition threshold value T₃ represents 20. Note that the second condition threshold value T₃ may represent a value other than 20.

In addition, in Equation 7, s₁, s₂, s₃, s₄, and s₅ represent a first coefficient, a second coefficient, a third coefficient, a fourth coefficient, and a fifth coefficient, respectively. In this example, the first coefficient s₁ to the fifth coefficient s₅ are set in advance.

In Equation 7, a represents a wave inclination, n represents the number of waves, and Fₐᵥₑ represents an average resistance force.

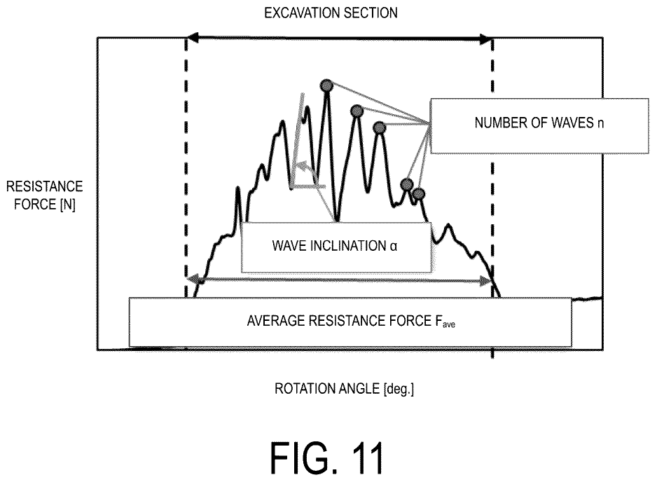

As shown in FIG. 11, the wave inclination α is a value obtained by averaging, in an excavation section, a value obtained by dividing a difference between a local minimum value and a local maximum value that are adjacent to each other in a change in resistance force by an angle difference that is a difference between rotation angles of two buckets corresponding to the local minimum value and the local maximum value.

The excavation section is a range of the rotation angle of the bucket in which the resistance force is larger than a predetermined threshold resistance force.

The number of waves n is the number of local maximum values in the change in resistance force in the excavation section.

The average resistance force Fₐᵥₑ is a value obtained by averaging the resistance force in the excavation section.

In this example, the wave inclination α, the number of waves n, and the average resistance force Fₐᵥₑ may be expressed as force-related parameters.

### Operation

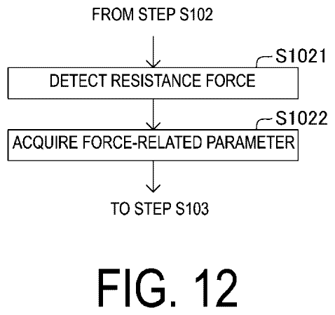

The soil property estimation device 1A of the second embodiment performs processing in which processing represented by step S1021 to step S1022 in FIG. 12 is added between step S102 and step S103 of the processing illustrated in FIG. 7, instead of the processing illustrated in FIG. 7.

When the information processing device 20 of the second embodiment executes step S101 and step S102, the information processing device 20 detects the resistance force in association with the rotation angle of the bucket in a period in which the construction machine excavates soil (step S1021).

Note that step S102 and step S1021 are executed in parallel in the period in which the construction machine excavates soil.

Next, the information processing device 20 acquires force-related parameters based on the resistance force detected in step S1021 (step S1022).

Next, the information processing device 20 performs the processing of step S103 to step S114 as in the first embodiment.

Next, the information processing device 20 acquires the most frequent value M and the frequency f_{M} of the most frequent value M in the histogram acquired in step S114, and estimates the soil property (in this example, the cone index q_{c}) based on the acquired most frequent value M, the acquired frequency f_{M} of the most frequent value M, and the force-related parameters acquired in step S1022 (step S115).

Note that the processing of step S1022 may be performed immediately after step S103, immediately before step S114, or immediately after step S114.

As described above, the soil property estimation device 1A of the second embodiment has operations and effects the same as or similar to those of the soil property estimation device 1 of the first embodiment.

Further, regarding the soil property estimation device 1A of the second embodiment, the construction machine excavates soil by moving the bucket thereof. Further, the soil property estimation device 1A includes a resistance force detection unit (in this example, the resistance force detector 121) that detects a resistance force received by the bucket in movement for excavating soil. Furthermore, the soil property estimation unit 220 estimates the soil property based on the extracted failure region and the detected resistance force.

The inventors of the present application have found that a relationship between the resistance force received by the bucket during movement and the soil property varies depending on a failure mode of soil. Thus, the soil property estimation device 1A detects the resistance force received by the bucket during movement, and estimates the soil property based on the failure region extracted in the captured image and the detected resistance force. This makes it possible to estimate the soil property with high accuracy.

Note that the present disclosure is not limited to the embodiments described above. For example, various changes that can be understood by those skilled in the art may be made to the above-described embodiments without departing from the spirit of the present disclosure.

### REFERENCE SIGNS LIST

1, 1A Soil property estimation device
11 Imaging device
12 Excavation device
121 Resistance force detector
20 Information processing device
21 Processing device
22 Storage device
23 Connection device
210 Captured image acquisition unit
220 Soil property estimation unit
221 Binary image generation unit
222 Boundary information generation unit
223 Failure region rectangle group information generation unit

1. A soil property estimation device comprising:
captured image acquisition processor circuitry configured to acquire a captured image that is an image generated by capturing an image of a target region including soil in a state of shear failure caused by excavation of the soil; and
soil property estimation processor circuitry configured to extract a failure region caused by the shear failure based on the captured image and to estimate a soil property that is a property of the soil based on the extracted failure region.

2. The soil property estimation device according to claim 1, wherein
the soil property estimation processor circuitry estimates the soil property based on at least one of a square ratio that increases as a rectangle including the extracted failure region approaches a square and a gradient ratio that increases as an angle at which a long side of the rectangle is inclined with respect to a reference line increases.

3. The soil property estimation device according to claim 2, wherein
the soil property estimation processor circuitry estimates the soil property based on a rectangle parameter that increases as the square ratio increases and that increases as the gradient ratio increases.

4. The soil property estimation device according to claim 3, wherein
the soil property estimation processor circuitry estimates the soil property based on a most frequent value and a frequency of the most frequent value in a histogram of the rectangle parameter.

5. The soil property estimation device according to claim 1, wherein
the excavation of the soil is performed by movement of a bucket of a construction machine,
the soil property estimation device further includes resistance force detection processor circuitry configured to detect a resistance force received by the bucket during the movement, and
the soil property estimation processor circuitry estimates the soil property based on the extracted failure region and the detected resistance force.

6. The soil property estimation device according to claim 2, wherein
the soil property estimation processor circuitry includes:
a binary image generator configured to perform, on the captured image, binarizing in which a value of each of a plurality of pixels constituting the captured image is converted into a first value or a second value based on a threshold value, and thus to generate a binary image,
a boundary information generator configured to perform, on the binary image, boundary extracting in which a boundary between a region having the first value and a region having the second value is extracted and thus to generate boundary information representing the boundary, and
a failure region rectangle group information generator configured to perform, on the boundary information, discarding in which a failure region rectangle candidate meeting a predetermined discarding condition is discarded from among a failure region rectangle candidate group that is a rectangle group including a closed curve group included in the boundary represented by the boundary information, and thus to generate failure region rectangle group information representing a failure region rectangle group that is a failure region rectangle candidate group not meeting the predetermined discarding condition among the failure region rectangle candidate group, and
an individual failure region rectangle group represented by the generated failure region rectangle group information is a rectangle including the extracted failure region.

7. The soil property estimation device according to claim 6, wherein
the excavation of the soil is performed by movement of a bucket of a construction machine along a reference plane, and
the binary image generator uses, as the threshold value, a maximum value of a local minimum value or local minimum values in changes in values of pixels along a straight line parallel to the reference plane in the captured image.

8. The soil property estimation device according to claim 6, wherein
the binary image generator performs the binarizing on each of a plurality of threshold values different from each other, and thus to generate a plurality of binary images,
the boundary information generator performs the boundary extracting on each of the plurality of binary images and thus to generate a plurality of pieces of the boundary information,
the failure region rectangle group information generator performs the discarding on the plurality of pieces of boundary information and thus to generate the failure region rectangle group information, and
the discarding condition includes a duplication discarding condition that a center of another failure region rectangle candidate is included inside a failure region rectangle candidate that is a determination target.

9. The soil property estimation device according to claim 8, wherein
the excavation of the soil is performed by movement of a bucket of a construction machine along a reference plane, and
the binary image generator uses, for each of a plurality of straight lines parallel to the reference plane and different from each other, a maximum value of a local minimum value or local minimum values in changes in values of pixels along the straight line in the captured image, as the plurality of threshold values.

10. The soil property estimation device according to claim 1, wherein
the parameter representing the soil property includes at least one of a cone index, cohesion, and an internal friction angle.

11. The soil property estimation device according to claim 1, wherein
the soil property is represented by at least one of a type of the soil and a state of the soil, and
a parameter representing the state of the soil includes at least one of a water content, a degree of saturation, and a volumetric water content.

12. A soil property estimation method comprising:
acquiring a captured image that is an image generated by capturing an image of a target region including soil in a state of shear failure caused by excavation of the soil;
extracting a failure region caused by the shear failure based on the captured image; and
estimating a soil property that is a property of the soil based on the extracted failure region.

13. A non-transitory computer-readable medium storing a soil property estimation program that, when executed by a computer, causes the computer to perform:
acquiring a captured image that is an image generated by capturing an image of a target region including soil in a state of shear failure caused by excavation of the soil;
extracting a failure region caused by the shear failure based on the captured image; and
estimating a soil property that is a property of the soil based on the extracted failure region.

14. The soil property estimation device according to claim 2, wherein
the excavation of the soil is performed by movement of a bucket of a construction machine,
the soil property estimation device further includes resistance force detection processor circuitry configured to detect a resistance force received by the bucket during the movement, and
the soil property estimation processor circuitry estimates the soil property based on the extracted failure region and the detected resistance force.

15. The soil property estimation device according to claim 3, wherein
the excavation of the soil is performed by movement of a bucket of a construction machine,
the soil property estimation device further includes resistance force detection processor circuitry configured to detect a resistance force received by the bucket during the movement, and
the soil property estimation processor circuitry estimates the soil property based on the extracted failure region and the detected resistance force.

16. The soil property estimation device according to claim 4, wherein
the excavation of the soil is performed by movement of a bucket of a construction machine,
the soil property estimation device further includes resistance force detection processor circuitry configured to detect a resistance force received by the bucket during the movement, and
the soil property estimation processor circuitry estimates the soil property based on the extracted failure region and the detected resistance force.

17. The soil property estimation device according to claim 3, wherein
the soil property estimation processor circuitry includes:
a binary image generator configured to perform, on the captured image, binarizing in which a value of each of a plurality of pixels constituting the captured image is converted into a first value or a second value based on a threshold value, and thus to generate a binary image, a boundary information generator configured to perform, on the binary image,
boundary extracting in which a boundary between a region having the first value and a region having the second value is extracted and thus to generate boundary information representing the boundary, and
a failure region rectangle group information generator configured to perform, on the boundary information, discarding in which a failure region rectangle candidate meeting a predetermined discarding condition is discarded from among a failure region rectangle candidate group that is a rectangle group including a closed curve group included in the boundary represented by the boundary information, and thus to generate failure region rectangle group information representing a failure region rectangle group that is a failure region rectangle candidate group not meeting the predetermined discarding condition among the failure region rectangle candidate group, and
an individual failure region rectangle group represented by the generated failure region rectangle group information is a rectangle including the extracted failure region.

18. The soil property estimation device according to claim 4, wherein
the soil property estimation processor circuitry includes:
a binary image generator configured to perform, on the captured image, binarizing in which a value of each of a plurality of pixels constituting the captured image is converted into a first value or a second value based on a threshold value, and thus to generate a binary image,
a boundary information generator configured to perform, on the binary image, boundary extracting in which a boundary between a region having the first value and a region having the second value is extracted and thus to generate boundary information representing the boundary, and
a failure region rectangle group information generator configured to perform, on the boundary information, discarding in which a failure region rectangle candidate meeting a predetermined discarding condition is discarded from among a failure region rectangle candidate group that is a rectangle group including a closed curve group included in the boundary represented by the boundary information, and thus to generate failure region rectangle group information representing a failure region rectangle group that is a failure region rectangle candidate group not meeting the predetermined discarding condition among the failure region rectangle candidate group, and
an individual failure region rectangle group represented by the generated failure region rectangle group information is a rectangle including the extracted failure region.
